(19) United States
(12) Patent Application Publication
(10) Pub. No.: US 2023/0365288 A1
(43) Pub. Date: Nov. 16, 2023

(54) HARD SHELL SADDLE BAGS

(71) Applicant: Moshe Chaim Ephraim Block, Valley Village, CA (US)

(72) Inventor: Moshe Chaim Ephraim Block, Valley Village, CA (US)

(21) Appl. No.: 18/318,473

(22) Filed: May 16, 2023

Related U.S. Application Data
(60) Provisional application No. 63/342,481, filed on May 16, 2022.

(51) Int. Cl. B65D 1/22; B65D 25/22; B65D 43/02

(52) U.S. Cl. CPC B65D 1/22; B65D 25/22; B65D 43/0202; B65D 2543/00194

(57) ABSTRACT

Implementations herein solve some or all of the shortcomings of conventional saddle bags by providing for hard shell saddle bags. Hard shell saddle bags may include a rigid shell and a secure lid closable to secure therein roadside tools and equipment, and may be mountable at various locations on a bicycle. Hard shell saddle bags as disclosed herein provide for secure attachment, closure, and organized storage of roadside tools and equipment, without movement, swaying, or shifting of roadside tools and equipment within the hard shell saddle bag. Hard shell saddle bags as disclosed herein may be mounted to a bicycle at various locations, including, for example, under the seat or to the handlebars. Furthermore, hard shell saddle bags as disclosed herein provide for mounting of accessories such as cameras or lights, which have high visibility and access.

### CROSS REFERENCE TO RELATED APPLICATIONS

This application claims priority to U.S. Provisional Application No. 63/342,481, filed on 16 May 2022, the entire disclosure of which is hereby incorporated by reference.

### BACKGROUND

Bicycles used by professional and recreational cyclists can break down during use. For example, a chain may derail, a tire may lose pressure, a fastener may loosen, among a variety of other potential problems. Cyclists often require access to tools and other equipment necessary to remedy such problems while away from a general storage location for such tools and equipment. For example, a cyclist may need access to an inflation device to inflate a high-pressure tire that has become flat via pressure loss. Or, a cyclist may need to replace a tire's tube and inflate the same.

### BRIEF DESCRIPTION OF THE FIGURES

For a fuller understanding of the nature and objects of the disclosure, reference should be made to the following detailed description taken in conjunction with the accompanying drawings, in which:

FIGS. 1A-1D illustrate a hard shell saddle bag, according to one or more implementations;

FIG. 2 illustrates a cycling system including a hard shell saddle bag, according to one or more implementations; and

FIG. 3 illustrates a cycling system including a hard shell saddle bag, according to one or more implementations.

### DETAILED DESCRIPTION

It is to be understood that the invention is not limited in its application to the details of construction and the arrangements of components and/or method steps set forth in the following description or illustrated in the drawings, and phraseology and terminology used herein is for the purpose of description and should not be regarded as limiting. The invention is capable of other embodiments and of being practiced or being carried out in various ways. Accordingly, other aspects, advantages, and modifications will be apparent to those skilled in the art to which the invention pertains, and these aspects and modifications are within the scope of the invention, which is limited only by the appended claims.

Tools and equipment frequently required for roadside repair of bicycles are often transported with the cyclist. Conventionally, this is accomplished via a wearable pack (e.g., a backpack or a “fanny” pack) or a saddle bag mounted on the bicycle itself.

Conventional saddle bags are often mounted underneath a bicycle seat. They comprise flexible materials (e.g., nylon, polyester, fabric, etc.) and designed to accommodate some or all of a set of tools for roadside repair of a bicycle. Such conventional saddle bags are mounted to the bicycle via a hook-and-loop attachment and closed using a zipper fastener.

Shortcomings of conventional saddle bags include that the hook-and-loop attachment can come loose during use, at least in part due to the motion and vibration of the bicycle when operational on a road. Furthermore, conventional saddle bags may be oversized relative to the roadside tool and equipment needs of the cyclist, and may be thus unorganized due to roadside tools and equipment shifting within the saddle bag when mounting or during operation of the bicycle. Furthermore, such conventional saddle bags do not provide for the mounting of an accessory, such as a camera, light, and others. Furthermore, conventional saddle bags are limited in mounting location— due to their flexible nature, they can only be practically mounted under the seat of the bicycle.

Implementations herein solve some or all of the shortcomings of conventional saddle bags by providing for hard shell saddle bags. Hard shell saddle bags may include a rigid shell and a secure lid closable to secure therein roadside tools and equipment, and may be mountable at various locations on a bicycle. Hard shell saddle bags as disclosed herein provide for secure attachment, closure, and organized storage of roadside tools and equipment, without movement, swaying, or shifting of roadside tools and equipment within the hard shell saddle bag. Hard shell saddle bags as disclosed herein may be mounted to a bicycle at various locations, including, for example, under the seat or to the handlebars. Furthermore, hard shell saddle bags as disclosed herein provide for mounting of accessories such as cameras or lights, which have high visibility and access.

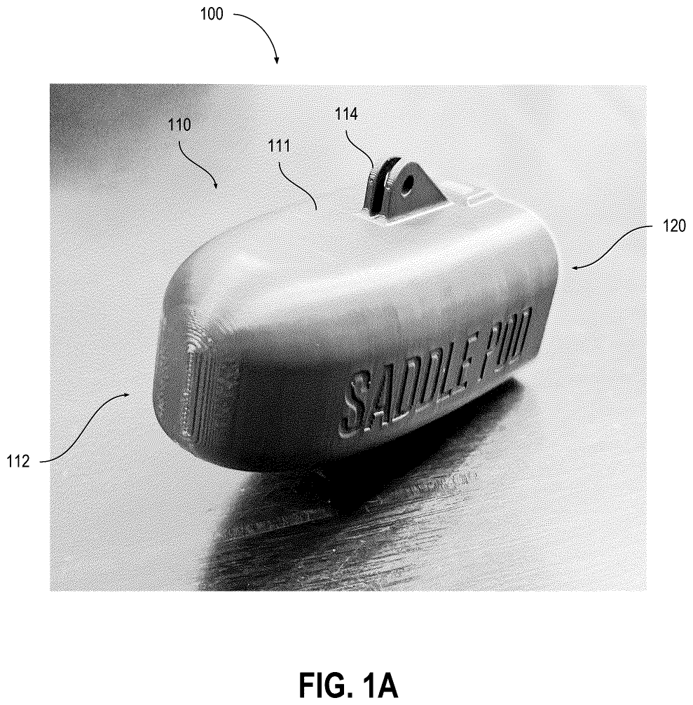

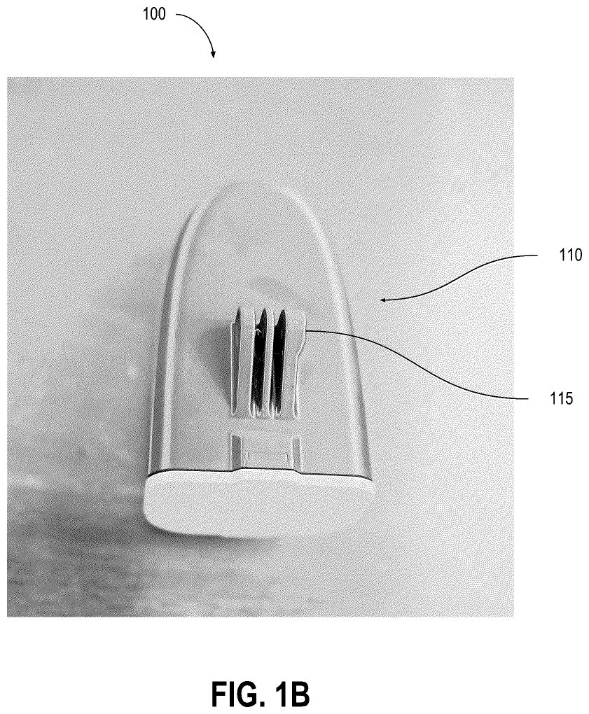

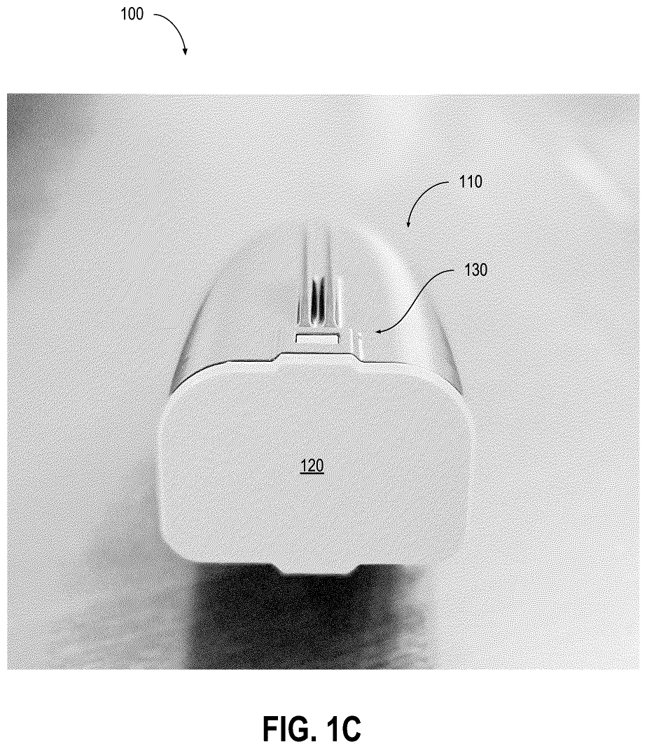

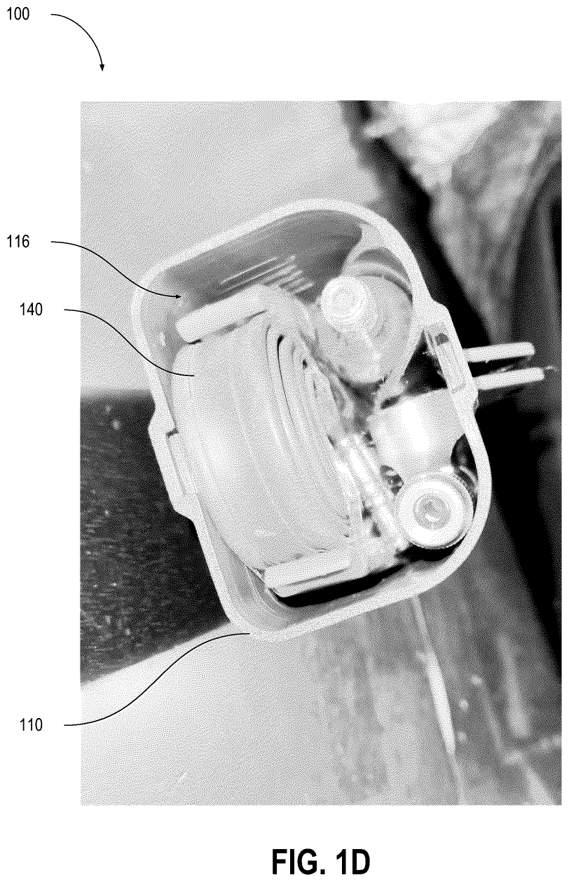

FIGS. 1A-1D illustrate a hard shell saddle bag 100, according to one or more implementations. The hard shell saddle bag 100 may provide for secure mounting to various attachment locations of a bicycle. The hard shell saddle bag 100 may provide for secure storage of roadside tools and equipment therein. A commercial embodiment of the hard shell saddle bag 100 is known as the Saddle Pod,

Hard shell saddle bag 100 may include a rigid receptacle 110. Rigid receptacle 110 may comprise a material of sufficient rigidity to prevent deformation of rigid receptacle 110 during handling, mounting, or operation of the bicycle to which hard shell saddle bag 100 may be attached. For example, rigid receptacle 110 may comprise plastics (e.g., ABS, polycarbonate, etc.), nylon, carbon fiber, metal, composite, or another sufficiently rigid material.

Rigid receptacle 110 may include a side wall 111 and a base wall 112. Side wall 111 may be disposed on base wall 112 such that side wall 111 and base wall 112 define a cavity 116 having an opening distal to base wall 112. Side wall 111 may have a substantially rectangular cross-section having rounded corners. Side wall 111 may have a variety of other cross-sections, including circular, triangular, polygonal, or other irregularly shaped cross-sections.

Side wall 111 may be tapered, for example, such that its cross-section changes in enclosed area as distance from base wall 112 increases. In some implementations, the area enclosed by cross sections of side wall 111 may increase as distance from base wall 112 increases. In other implementations, the area enclosed by cross sections of side wall 111 may decrease as distance from base wall 112 increases. In yet further implementations, the area enclosed by cross sections of side wall 111 may increase, and then decrease as distance from base wall 112 increases. Such tapering may be selected to maximize aerodynamic efficiency or otherwise control aerodynamic characteristics of hard shell saddle bag 100 for given velocities of air impingement thereon (e.g., 10-40 mph, in some examples, 20 mph).

Base wall 112 may be defined by a substantially extended pyramidal shape (e.g., a hip) and may have a rounded peak (e.g., point, peak line).

Side wall 111 and base wall 112 may be monolithic (e.g., of one piece).

Side wall 111 may further include an action mount 115. Action mount 115 may be configured for mounting of an accessory (e.g., a camera or a lighting accessory) thereto. Such an action mount may include a variety of attachment means sufficient to attach an accessory to hard shell saddle bag 100.

Hard shell saddle bag 100 may include a lid 120 integrated (e.g., attached via a hinge) to rigid receptacle 110. Lid 120 may be configured to cover the opening to cavity 116 when in a closed position, secured to rigid receptacle 110 by latching mechanism 130, thereby enclosing cavity 116. A cyclist may access cavity 116 by unlatching latching mechanism 130 and rotating lid 120 away from the closed position.

Cavity 116 may be configured for storage of roadside tools and equipment (e.g., bicycle repair tools 140) of a cyclist. Cavity 116 may, in some implementations, be fully hollow, and in other implementations, may include dividers configured for storage of particularly-sized roadside tools and equipment.

Rigid receptacle 110 may further include a mount point 114, which may be integral and/or monolithic thereto, for mounting hard shell saddle bag 100 to a bicycle. Mount point 114 may include a mounting tab. Each tab of mount point 114 may be monolithic with side wall 111 and defined by a common through-hole. The common through hole may be sized such that a mating tab of a bicycle may be aligned therewith. The mount point 114 and the bicycle may thus be mechanically joined via, for example, a bolt and nut to form a mechanical connection therebetween.

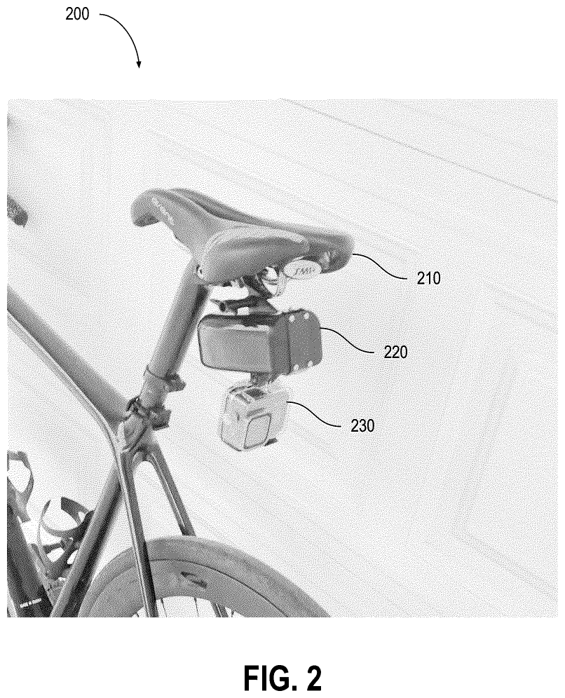

FIG. 2 illustrates a cycling system 200 including a hard shell saddle bag 220, according to one or more implementations. Cycling system 200 may include a seat-mounted hard shell saddle bag 220, which may provide for secure and hidden storage of roadside tools and equipment.

In cycling system 200, hard shell saddle bag 220 may be mounted to or proximate a seat 210 of cycling system 200. Seat 210 may include a mounting point, or alternatively a post of seat 210 or the frame proximate seat 210 may include a mounting point. In this way, hard shell saddle bag 220 may be attached to the bicycle of cycling system 200, and may provide for mounting of an accessory 230 (e.g., a camera) thereto (e.g., via an action mount, a threaded connection, etc.).

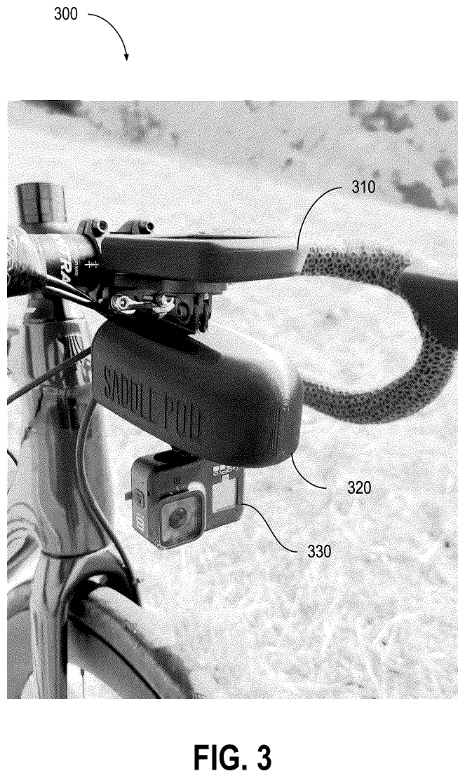

FIG. 3 illustrates a cycling system 300 including a hard shell saddle bag 320, according to one or more implementations. Cycling system 300 may include a handlebar-mounted hard shell saddle bag 320, which may provide for secure storage of roadside tools and equipment.

In cycling system 300, hard shell saddle bag 320 may be mounted to or proximate a handlebar 310 of cycling system 300. Handlebar 310 may include a mounting point, or alternatively a subassembly of handlebar 310 or the frame proximate handlebar 310 may include a mounting point. In this way, hard shell saddle bag 320 may be attached to the bicycle of cycling system 300, and may provide for mounting of an accessory 330 (e.g., a camera) thereto.

Various characteristics, advantages, implementations, embodiments, and/or examples relating to the invention have been described in the foregoing description with reference to the accompanying drawings. However, the above description and drawings are illustrative only. The invention is not limited to the illustrated implementations, embodiments, and/or examples, and all implementations, embodiments, and/or examples of the invention need not necessarily achieve every advantage or purpose, or possess every characteristic, identified herein. Accordingly, various changes, modifications, or omissions may be effected by one skilled in the art without departing from the scope or spirit of the invention, which is limited only by the appended claims. Although example materials and dimensions have been provided, the invention is not limited to such materials or dimensions unless specifically required by the language of a claim. Elements and uses of the above-described implementations, embodiments, and/or examples can be rearranged and combined in manners other than specifically described above, with any and all permutations within the scope of the invention, as limited only by the appended claims.

In the claims, various portions may be prefaced with letter or number references for convenience. However, use of such references does not imply a temporal or ordered relationship not otherwise required by the language of the claims. Unless the phrase ‘means for’ or ‘step for’ appears in a particular claim or claim limitation, such claim or claim limitation should not be interpreted to invoke 35 U.S.C. § 112(f).

As used herein, satisfying a threshold may, depending on the context, refer to a value being greater than the threshold, greater than or equal to the threshold, less than the threshold, less than or equal to the threshold, equal to the threshold, and/or the like, depending on the context.

As used in the specification and in the claims, use of “and” to join elements in a list forms a group of all elements of the list. For example, a list described as comprising A, B, and C defines a list that includes A, includes B, and includes C. As used in the specification and in the claims, use of “or” to join elements in a list forms a group of at least one element of the list. For example, a list described as comprising A, B, or C defines a list that may include A, may include B, may include C, may include any subset of A, B, and C, or may include A, B, and C. Unless otherwise stated, lists herein are inclusive, that is, lists are not limited to the stated elements and may be combined with other elements not specifically stated in a list. As used in the specification and in the claims, the singular form of ‘a’, ‘an’, and ‘the’ include plural referents (e.g., one or more of the referent) unless the context clearly dictates otherwise.

It is to be expressly understood that the drawings are for the purpose of illustration and description only and are not intended as a definition of the limits of the invention.

It is to be expressly understood that the drawings are for the purpose of illustration and description only and are not intended as a definition of the limits of the invention.

Unless otherwise stated, any range of values disclosed herein sets out a lower limit value and an upper limit value, and such ranges include all values and ranges between and including the limit values of the stated range, and all values and ranges substantially within the stated range as defined by the order of magnitude of the stated range.

The inventors hereby state their intent to rely on the Doctrine of Equivalents to determine and assess the reasonably fair scope of their invention as pertains to any apparatus not materially departing from but outside the literal scope of the invention as set out in the following claims.

I claim:

1. A hard shell saddle bag, comprising:
a rigid monolithic receptacle including a side wall and a base wall, the side wall disposed on the base wall such that the side wall and the base wall define a cavity having an opening distal to the base wall, wherein the side wall is defined in part by a cross-section that is substantially rectangular having rounded corners, wherein the base wall is defined by a substantially extended pyramidal shape having a rounded peak, wherein the side wall is further defined by an action mount configured for mounting of an accessory thereto;
a lid integrated to the side wall distal to the base wall, the lid configured to cover the opening when in a closed position, thereby enclosing the cavity; and
a mount point integral with the side wall comprising a mounting tab, each tab monolithic with the side wall and defined by a common through hole, wherein the common through hole is sized such that a mating tab of a bicycle may be aligned therewith and the mounting tab and the mating tab may be mechanically joined via a bolt and nut, thereby forming a mechanical connection with the bicycle;
wherein the cavity is defined by the base wall and the side wall and configured to be enclosed by the lid such that a bicycle repair tool may be disposed therein.

2. The hard shell saddle bag of claim 1, wherein the accessory is a video camera or a lighting accessory.

3. The hard shell saddle bag of claim 1, wherein the rigid monolithic receptacle comprises carbon fiber, plastic, or a composite material.

4. The hard shell saddle bag of claim 1, wherein the side wall is tapered such that the cross-section of the side wall increases in enclosed area as a distance from the base wall increases.

5. The hard shell saddle bag of claim 1, wherein the side wall is tapered such that the cross-section of the side wall decreases in enclosed area as a distance from the base wall increases.

6. The hard shell saddle bag of claim 1, wherein the rounded peak of the substantially extended pyramidal shape is configured to maximize aerodynamic efficiency when impinged with air traveling at 20 miles per hour.

7. A hard shell saddle bag, comprising:
a rigid monolithic receptacle including an side wall and a base wall, the side wall disposed on the base wall such that the side wall and the base wall define a cavity having an opening distal to the base wall, wherein the side wall is defined in part by a cross-section that is substantially rectangular having rounded corners, wherein the base wall is defined by a substantially extended pyramidal shape having a rounded peak, wherein the side wall is further defined by an action mount configured for mounting of a accessory thereto;
a lid integrated to the side wall distal to the base wall, the lid configured to cover the opening when in a closed position, thereby enclosing the cavity;
an mount point integral with the side wall configured for forming a mechanical connection with a bicycle.

8. The hard shell saddle bag of claim 7, wherein the accessory is a video camera.

9. The hard shell saddle bag of claim 7, wherein the action mount comprises a threaded connection.

10. The hard shell saddle bag of claim 7, wherein the accessory is a lighting accessory.

11. The hard shell saddle bag of claim 7, wherein the side wall is tapered such that the cross-section of the side wall increases in enclosed area as a distance from the base wall increases.

12. The hard shell saddle bag of claim 7, wherein the side wall is tapered such that the cross-section of the side wall decreases in enclosed area as a distance from the base wall increases.

13. The hard shell saddle bag of claim 7, wherein the rounded peak of the substantially extended pyramidal shape is configured to maximize aerodynamic efficiency when impinged with air traveling at 20 miles per hour.

14. The hard shell saddle bag of claim 7, wherein the cavity is defined by the base wall and the side wall and configured to be enclosed by the lid such that a bicycle repair tool may be disposed therein.

15. The hard shell saddle bag of claim 7, wherein the mount point comprises a mounting tab, each tab monolithic with the side wall and defined by a common through hole, wherein the common through hole is sized such that a mating tab of a bicycle may be aligned therewith and the mounting tab and the mating tab may be mechanically joined via a bolt and nut, thereby forming the mechanical connection with the bicycle.

16. A hard shell saddle bag, comprising:
a rigid receptacle including an side wall and a base wall, the side wall disposed on the base wall such that the side wall and the base wall define a cavity having an opening distal to the base wall, wherein the side wall is defined in part by a cross-section that is substantially rectangular having rounded corners, wherein the base wall is defined by a substantially extended pyramidal shape having a rounded peak, wherein the side wall is further defined by an action mount configured for mounting of a accessory thereto;
a lid integrated to the side wall distal to the base wall, the lid configured to cover the opening when in a closed position, thereby enclosing the cavity;
an mount point integral with the side wall configured for forming a mechanical connection with a bicycle.

17. The hard shell saddle bag of claim 16, wherein the rigid receptacle is monolithic.

18. The hard shell saddle bag of claim 16, wherein the side wall is tapered such that the cross-section of the side wall increases in enclosed area as a distance from the base wall increases.

19. The hard shell saddle bag of claim 16, wherein the side wall is tapered such that the cross-section of the side wall decreases in enclosed area as a distance from the base wall increases.

20. The hard shell saddle bag of claim 16, wherein the cavity is defined by the base wall and the side wall and configured to be enclosed by the lid such that a bicycle repair tool may be disposed therein.
